(19) United States
(12) Patent Application Publication
(10) Pub. No.: US 2025/0030477 A1
(43) Pub. Date: Jan. 23, 2025

(54) METHOD OF PROVIDING EDGE COMPUTING SERVICE AND NETWORK THEREFOR

(71) Applicant: HYUNDAI MOBIS CO., LTD., Seoul (KR)

(72) Inventor: Dae Gon SON, Seoul (KR)

(73) Assignee: HYUNDAI MOBIS CO., LTD., Seoul (KR)

(21) Appl. No.: 18/673,993

(22) Filed: May 24, 2024

(30) Foreign Application Priority Data
Jul. 20, 2023 (KR) 10-2023-0094488

(51) Int. Cl. H04B 7/185

(52) U.S. Cl. CPC H04B 7/18504

(57) ABSTRACT

A method of providing an edge computing service to a user equipment (UE) in a network of a mobile communication system and a network apparatus therefor are provided. The method includes: receiving a service request signal from the UE; determining an edge server type to support the UE, based on information included in the service request signal; determining an edge server to support the UE, based on the edge server type determined to support the UE; and providing the edge computing service to the UE through the edge server.

### CROSS-REFERENCE TO RELATED APPLICATION(S)

Pursuant to 35 U.S.C. § 119 (a), this application claims the benefit of an earlier filing date and right of priority to Korean Application No. 10-2023-0094488, filed on Jul. 20, 2023, in the Korean Intellectual Property Office, the entire contents of which are hereby incorporated by reference for all purposes.

### BACKGROUND

### 1. Field

The following description relates to a method of providing an edge computing service to a user equipment (UE) in a network of a mobile communication system and the network therefor.

### 2. Description of the Related Art

A wireless communication system has used various technologies such as LTE, LTE-Advanced, and Wi-Fi, and 5G is also included in the technologies. Three key requirement areas of 5G include (1) enhanced mobile broadband (eMBB), (2) massive machine type communication (mMTC), and (3) ultra-reliable and low latency communication (URLLC) areas. Some use cases may require multiple areas for optimization, while others may focus only on one key performance indicator (KPI). 5G supports such diverse use cases in a flexible and reliable way.

Thereamong, URLLC includes new services which will transform industries through ultra-reliable/available, low latency links such as remote control of critical infrastructure and self-driving vehicles. The levels of reliability and latency are essential to smart-grid control, industrial automation, robotics, drone control and coordination.

The above-described URLLC technology may be a sort of method of providing important communication services with ultra-reliability and low latency. However, even in this case, there may be limitations in supporting communication in a coverage shadow area for drones or other types of UEs with high mobility, and edge computing technology is required to provide faster and more stable services to UEs of high mobility.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

Embodiments of the present disclosure provide a method of providing an edge computing service to a UE in a network of a mobile communication system and the network therefor.

Specifically, the embodiments of the present disclosure provide an edge computing service that implements an edge server not only as a ground edge server but also as an aerial edge server and is suitable for a service request of a user by defining each of the ground edge server and the aerial edge server as a different edge server type.

In other words, the embodiments of the present disclosure provide a specific method and network structure for providing the edge computing service by specifying the type of the edge server to support a UE and/or a specific edge server of that type, based on a service request signal received from the UE.

The objects to be achieved by the present disclosure are not limited to what has been particularly described hereinabove and other objects not described herein will be more clearly understood by persons skilled in the art from the following detailed description.

In a general aspect of the disclosure, a method of providing an edge computing service to a user equipment (UE) in a network of a mobile communication system, includes: receiving a service request signal from the UE; determining an edge server type to support the UE, based on information included in the service request signal; determining an edge server to support the UE, based on the edge server type determined to support the UE; and providing the edge computing service to the UE through the edge server.

The edge server type may be a ground edge server type or an aerial edge server type.

The aerial edge server type may be associated with an aerial edge server including one or more drones, or an aerial edge server including one or more satellites.

The determining of the edge server type may include determining the edge server to support the UE as being any one of the ground edge server type and the aerial edge server type, based on the information included in the service request signal.

The information included in the service request signal may include one or more of location information of the UE, channel quality information, service type information, and capability information of the UE.

The network is in communication with a central server, wherein the UE comprises an uncrewed aerial vehicle (UAV), and wherein the service request signal is received by the central server via a ground base station or an aerial base station.

The information included in the service request signal may include one or more of vertiport information and corridor information of the UAV.

The central server may be configured to: determine the edge server type to support the UE as a ground edge server type or an aerial edge server type; and determine the edge server to support the UE among one or more edge servers related to the edge server type, based on one or more of the vertiport information and the corridor information.

The UE may be one among unmanned ground vehicles (UGVs) and unmanned aerial vehicles (UAVs), and the aerial edge server may be one among aerial edge servers that provide edge computing service to the UGVs or UAVs.

The method may further include selecting the aerial edge server based on at least one of location information of the UE, movement path information of the UE, required quality levels of the UE, or any combination thereof, by using an Artificial Intelligence (AI) model.

In another general aspect of the disclosure, a network apparatus of a mobile communication system for providing an edge computing service to a user equipment (UE), includes: one or more processors; and a computer memory operably connected to the one or more processors and storing instructions that, when executed, configure the one or more processors to: receive a service request signal from the UE; determine an edge server type to support the UE, based on information included in the service request signal; determine an edge server to support the UE, based on the edge server type determined to support the UE; and provide the edge computing service to the UE through the edge server.

The edge server type may be a ground edge server type or an aerial edge server type.

The aerial edge server type may be associated with an aerial edge server including one or more drones or an aerial edge server including one or more satellites.

The one or more processors may be further configured to determine the edge server to support the UE as being any one of the ground edge server type and the aerial edge server type, based on the information included in the service request signal.

The information included in the service request signal may include one or more of location information of the UE, channel quality information, service type information, and capability information of the UE.

The network apparatus may include a central server, wherein the UE includes an uncrewed aerial vehicle (UAV), and wherein the service request signal is received by the central server via a ground base station or an aerial base station.

The information included in the service request signal may include one or more of vertiport information and corridor information of the UAV.

The central server may be configured to: determine the edge server type to support the UE as a ground edge server type or an aerial edge server type: and determine the edge server to support the UE among one or more edge servers related to the edge server type, based on one or more of the vertiport information and the corridor information.

The UE may be one among unmanned ground vehicles (UGVs) and unmanned aerial vehicles (UAVs), and the aerial edge server may be one among aerial edge servers that provide edge computing service to the UGVs or UAVs.

The aerial edge server may be selected based on at least one of location information of the UE, movement path information of the UE, required quality levels of the UE, or any combination thereof, by using an Artificial Intelligence (AI) model.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram illustrating the concept of an unmanned aerial system (UAS);

FIG. 2 is a diagram illustrating the concept of edge computing in a UAS;

FIG. 3 is a diagram illustrating the concept of an aerial edge server according to an exemplary embodiment of the present disclosure;

FIG. 4 is a diagram illustrating another utilization scenario of an aerial edge server according to an exemplary embodiment of the present disclosure.

FIG. 5 is a diagram illustrating a method of providing an edge computing service to a UE in a network of a mobile communication system according to an embodiment of the present disclosure;

FIG. 6 is a diagram illustrating a network configuration for providing an edge computing service and a method of providing the service using the network configuration according to an embodiment of the present disclosure;

FIG. 7 is a diagram illustrating a network configuration and a method of providing an edge computing service according to another embodiment of the present disclosure;

FIG. 8 illustrates wireless devices applicable to the present technology; and

FIG. 9 is a diagram illustrating an operation performed by a processor of a wireless device according to an embodiment of the present disclosure.

### DETAILED DESCRIPTION

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein. In the drawings, parts that are not related to a description of the present disclosure are omitted to clearly explain the present disclosure and similar reference numbers will be used throughout this specification to refer to similar parts.

In the specification, when a part “includes” an element, this means that the part may further include another element rather than excluding another element unless otherwise mentioned.

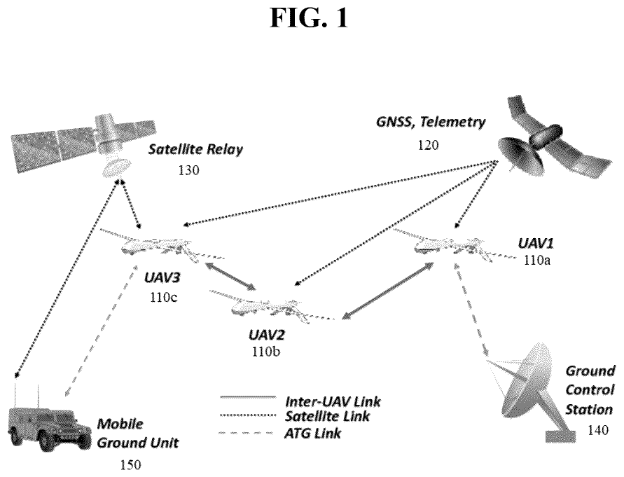

FIG. 1 is a diagram illustrating the concept of an unmanned aerial system (UAS).

As illustrated in FIG. 1, the UAS may include one or more uncrewed aerial vehicles (UAVs) 110a, 110b, and 110c (e.g., drones) and one or more ground control stations 140 (or ground control centers or ground control servers) that manage the UAVs. The UAS may cooperate with a mobile communication service provider system for providing an efficient communication service to the UAV(s).

In the following description, a “mobile communication system” is assumed to include a mobile communication service provider system, operated by a conventional mobile communication service provider, and a UAS. In this mobile communication system, a conventional mobile communication service and a UAS service may be defined by one communication standard specification (e.g., 3GPP standard specification).

Meanwhile, a network described below may be configured to cooperate with the mobile communication service provider system with the UAS. That is, the network described later is assumed to include a network of the mobile communication service provider system and a network for the UAS.

The UAV 110a, 110b, and 110c may be used as a concept that collectively refers to unmanned aerial logistics and/or transportation capable of vertical takeoff and landing. However, this is purely one embodiment, and the UAVs 110a, 110b, and 110c according to another embodiment of the present disclosure may conceptually further include manned air logistics and/or transportation capable of vertical takeoff and landing.

The mobile communication system may be configured to include a network including a base station (BS) and a core network, and various user devices cooperating with the network. Hereinafter, for convenience of description, the various user devices cooperating with the network will be collectively referred to as “UEs”.

In an embodiment, the network may not only cooperate with the ground control station 140, but may also additionally cooperate with a global navigation satellite system (GNSS) 120 for providing location information and/or a satellite relay 130 for satellite communication.

In an embodiment, the UE may be equipped with a global positioning system (GPS) receiver and may receive signals directly from the GNSS 120 and/or the satellite relay 130.

A network according to another embodiment may be used as a concept including all of a BS, a core network, and the ground control station 140. In this case, the mobile communication system may be used as a concept including the UAS.

Meanwhile, UEs that receive communication services from the UAS may include a mobile ground unit 150 as well as the UAVs 110a, 110b, and 110c described above. That is, in the following description, the “UEs” are assumed to be the UAVs 110a, 110b, and 110c for convenience of description. However, the UEs are not limited thereto and do not exclude the case in which the UEs include the mobile ground unit 150 as illustrated in FIG. 1 or a general mobile phone/smartphone.

In FIG. 1, an inter-UAV link is established between the UAVs 110a, 110b, and 110c. The inter-VAU link may correspond to a sidelink of the 3rd generation partnership project (3GPP). The UASs 110a, 110b, and 110c may have a satellite link established with the satellite units 120 and 130 and may be connected to the ground units 140 and 150 through an air-to-ground (ATG) link.

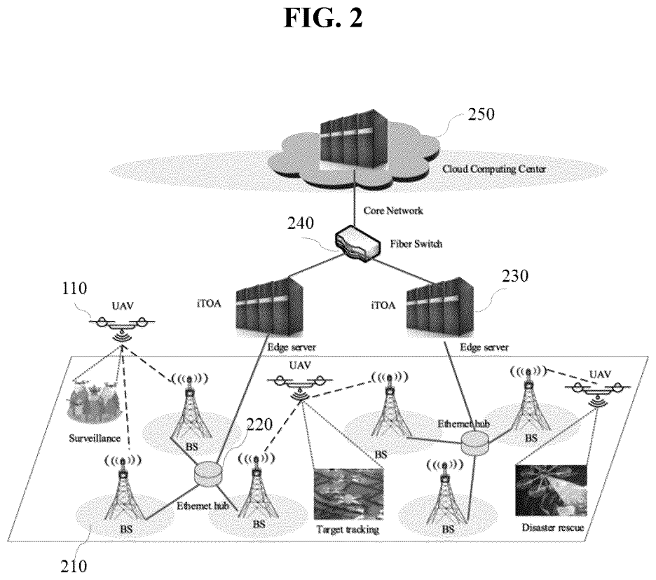

FIG. 2 is a diagram illustrating the concept of edge computing in a UAS.

FIG. 2 illustrates an example in which several UAVs 110 operate for surveillance, target tracking, and disaster rescue missions. In order to provide faster and more stable services to the UAVs 110, edge computing at a physically close location may be required, and FIG. 2 illustrates a general structure for this purpose.

The UAVs 110 may receive services by transmitting an edge computing service request to corresponding respective BSs 210. The BSs 210 may be connected to edge servers 230 through Ethernet hubs 220, and the edge servers 230 may be connected to a cloud computing sensor 250 through a fiber switch 240.

In an embodiment illustrated in FIG. 2, it is assumed that the edge server 230 is installed and operated on the ground, and the edge server 230 currently used is such a ground edge server 230. However, in an exemplary embodiment of the present disclosure, as will be described later, the concept of an “aerial edge server” is used to better match the purpose of edge computing, which is to provide a computing service at a location physically close to the UE, and a method of determining and using the type of an edge server that matches the needs of the UE using the concept is proposed.

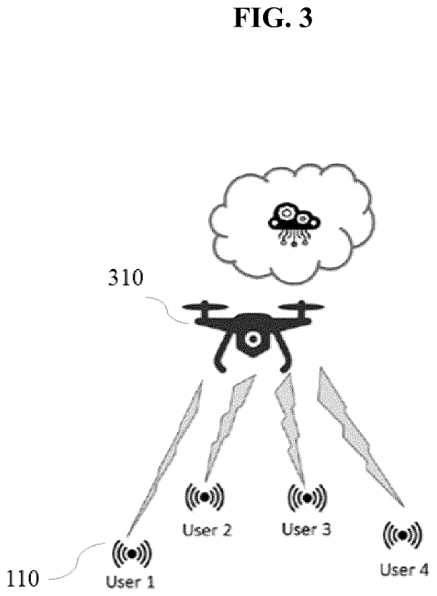

FIG. 3 is a diagram illustrating the concept of an aerial edge server according to an exemplary embodiment of the present disclosure.

FIG. 3 illustrates the concept in which another type of UAV performs the role of an aerial edge server 310 for UEs 110 of multiple types of UAVs. In order to implement the concept of edge computing, which is to provide a computing service at a location physically close to the UEs 110 in a UAS, it is useful to utilize such an aerial edge server 310. In FIG. 3, this aerial edge server 310 is implemented in the form of a UAV with capabilities for edge computing. However, in another embodiment of the present disclosure, a satellite or a floating device that moves in a limited corridor may be used as the aerial edge server.

Such an aerial edge server 310 may hereinafter be referred to as a mobile edge computing (MEC) device.

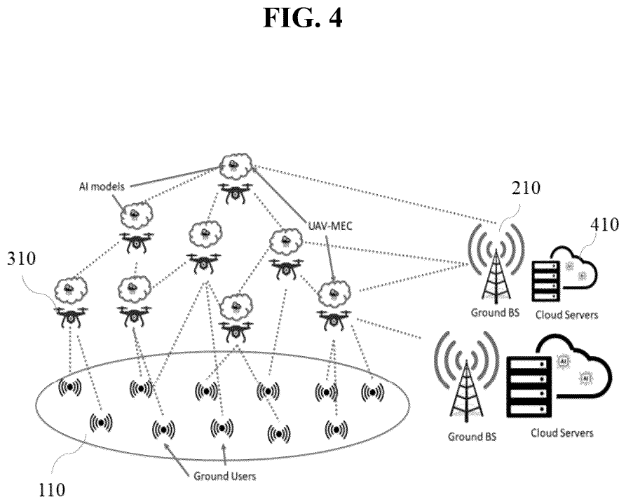

FIG. 4 is a diagram illustrating another utilization scenario of an aerial edge server according to an exemplary embodiment of the present disclosure.

The embodiment illustrated in FIG. 4 illustrates the concept of providing an edge computing service to a plurality of ground UEs 110 (e.g., unmanned ground vehicles (UGVs)) through aerial edge servers 310. In other words, the aerial edge servers 310 do not need to be used only for the aerial UEs 110 (e.g., unmanned aerial vehicles (UAVs)) as illustrated in FIG. 3 and may be used in consideration of the locations, movement paths, and required quality levels of the UEs 110, as well as movement information (e.g., acceleration, deceleration, speed, static/hover motion, etc.) of the UEs 110.

Which aerial edge servers 310 will support the UEs 110 may be determined using an AI model. FIG. 4 illustrates the concept of specifying the aerial edge servers 310 determined using this AI model.

The aerial edge servers 310 may communicate wirelessly with ground BSs 210 and may be controlled through cloud servers 410.

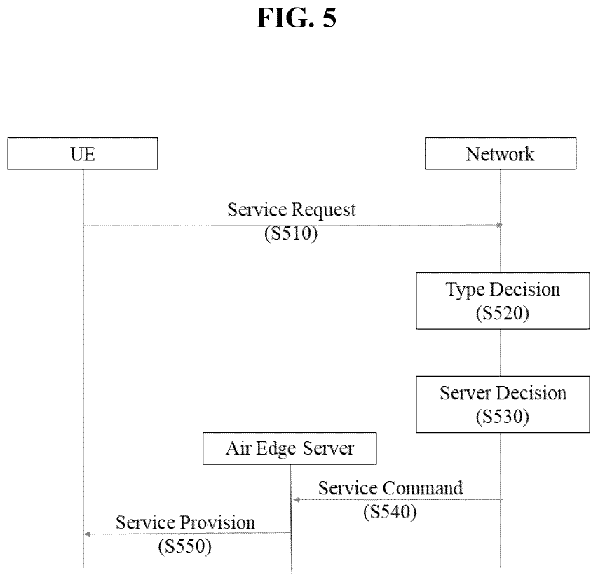

FIG. 5 is a diagram illustrating a method of providing an edge computing service to a UE in a network of a mobile communication system according to an embodiment of the present disclosure.

To provide the edge computing service to the UE, the network may receive a service request signal from the UE (S510). Information included in the service request signal may include one or more of location information of the UE, channel quality information (e.g., quality of service (QOS) information), service type information, and capability information of the UE.

Upon receiving the service request signal from the UE, the network may determine the type of an edge server to support the UE based on the information included in the service request signal (S520). In this case, the type of the edge server is proposed to include not only the ground edge server type but also the aerial edge server type, as described above with reference to FIGS. 3 and 4.

The aerial edge server type may correspond to a type representing an aerial edge server including one or more drones or an aerial edge server including one or more satellites. That is, determining the type of the edge server (S520) may include determining the edge server to support the UE as any one of the ground edge server type and the aerial edge server type, based on the information included in the service request signal.

Referring again to FIG. 5, the network may determine the edge server to support the UE based on the type of the edge server determined as described above (S530). For example, when the type of the edge server is determined as the aerial edge server to support the UE, the network may determine the edge server to support the UE among a plurality of aerial edge servers in consideration of location information, movement path information, required quality level, movement information (e.g., acceleration, deceleration, speed, static/hover motion, etc.) and the like of the UE.

In this way, when a specific aerial edge server is determined as the edge server to support the UE, the network may transmit a service support command to the corresponding aerial edge server (S540). Upon receiving the service support command, the aerial edge server may provide the edge computing service to the UE (S550).

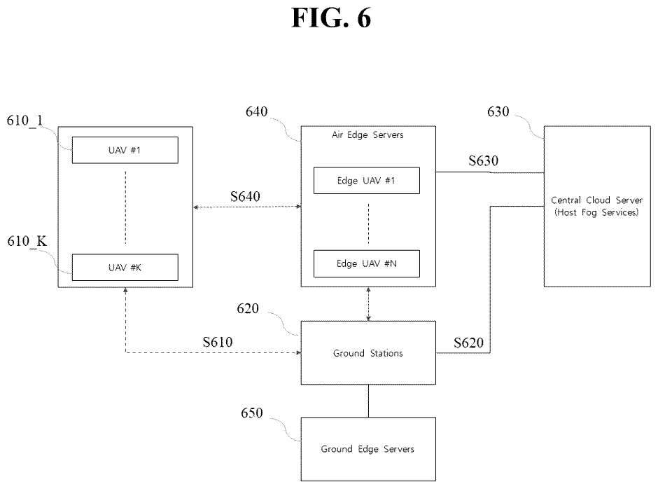

FIG. 6 is a diagram illustrating a network configuration for providing an edge computing service and a method of providing the service using the network configuration according to an embodiment of the present disclosure.

An example of FIG. 6 shows K UAVs 610_1 to 610_K as UEs. The UAVs 610_1 to 610_K may each transmit a signal for requesting the edge computing service to a ground BS 620 (S610).

Upon receiving the service request signal from the UAV, for example, the UAV 610_1, the BS 620 may forward the service request signal to a central cloud server (or host Fog server) 630 (S620). Upon receiving the request signal, the central cloud server 630 may determine an edge server type as one of a ground edge server 650 or an aerial edge server 640 in consideration of QoS included in the service request signal requested by the UAV 610_1.

When the edge server type is determined as the aerial edge server 640, the central cloud server 630 may transmit a service provision command to the aerial edge server 640 (S630). The aerial edge server 640 may provide the edge computing service to the UAV 610_1 based on the service provision command (S640).

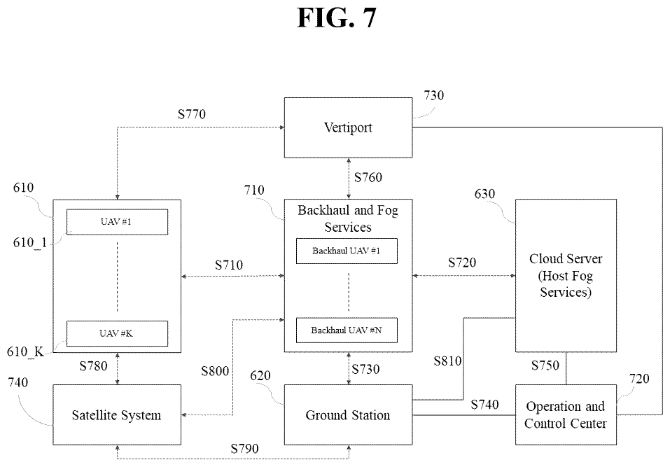

FIG. 7 is a diagram illustrating a network configuration and a method of providing an edge computing service according to another embodiment of the present disclosure.

In an example of FIG. 7, it is assumed that UEs are K UAVs 610_1 to 610_K. However, in the embodiment illustrated in FIG. 7, a UAV 610 transmits a service request signal not to a ground BS but to a backhaul UAV 710 that provides a backhaul/Fog service (S710). Upon receiving the service request signal, the backhaul UAV 710 may transmit the service request signal to a central server 630 (S720).

As illustrated in FIG. 7, the backhaul UAV 710 may communicate wirelessly with a ground BS 620 (S730). The backhaul UAV 710 may be configured to transmit the above-described service request signal to the central server 630 via the ground BS 620 and an operation and control center 720 instead of directly transmitting the service request signal to the central server 630 (S740 and S750). In this case, the central server 630 may additionally obtain movement path/corridor information from the operation and control center 720, in addition to information included in the service request signal requested by the UAV 610.

Meanwhile, the backhaul UAV 710 according to another embodiment of the present disclosure may directly transmit the service request signal received from the UAV 610 to the central server 630 (S720) and may transmit an additional information request signal to the ground BS 620 in order to provide additional information to the central server 630 (S730), so that the movement path/corridor information of the operation and control center 720 may be transmitted to the central server 630.

Meanwhile, the backhaul UAV 710 may obtain additional information about the UAV 610 (S760) by communicating with a vertiport 730 in which the UAV 610 may perform vertical takeoff and landing, as illustrated in FIG. 7. The vertiport 730 may be subjected to vertical takeoff and landing control through wireless communication with the UAV 610 (S770).

In addition, the embodiment of FIG. 7 illustrates the concept of the UAV 610 communicating with a satellite system 740 (S780). The satellite system 740 may also perform the role of the above-described aerial edge server. When the satellite system 740 serves as the aerial edge server, the ground BS 620 that has received the service request signal from the UAV 610 may perform control such that the satellite system 740 supports the edge computing service as the aerial edge server. This command may be based on command information received by the central server 630 (S810).

The satellite system 740 of FIG. 7 may be used not only as the aerial edge server but also for control of the backhaul UAVs 710 (S800).

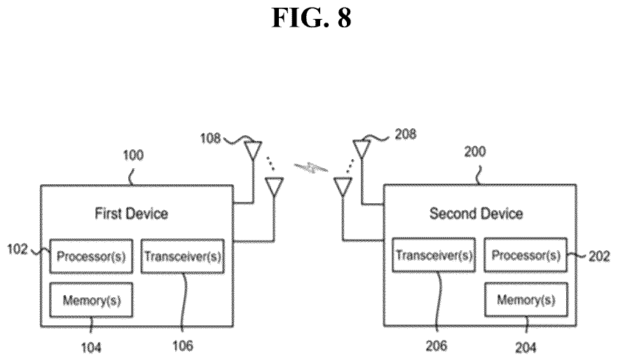

FIG. 8 illustrates wireless devices applicable to the present technology.

Referring to FIG. 8, a first wireless device 100 and a second wireless device 200 may transmit radio signals through various radio access technologies (RATs) (e.g., LTE and NR). Herein, the first wireless device 100 and the second wireless device 200 may correspond to the UE and the network in FIG. 1. Specifically, the first wireless device 100 and the second wireless device 200 may applied to various devices located at both ends of a communication link of the UAS illustrated in FIG. 1 or FIG. 2.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE E-UTRA or 5G NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 206 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE E-UTRA or 5G NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more protocol data units (PDUs) and/or one or more service data units (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operational flowcharts disclosed in this document may be implemented using firmware or software, and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process the received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

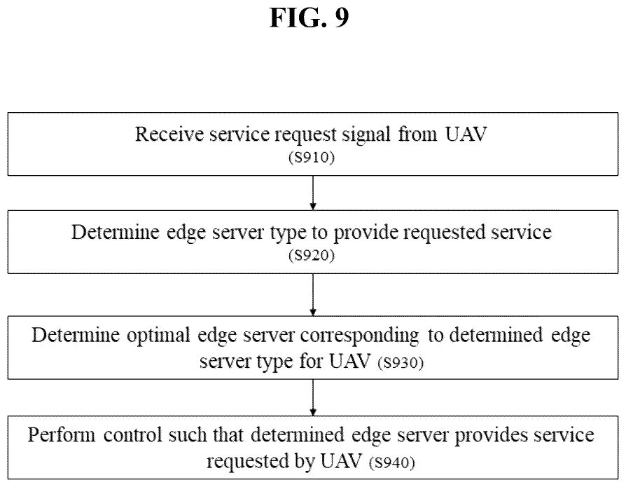

FIG. 9 is a diagram illustrating an operation performed by a processor of a wireless device according to an embodiment of the present disclosure.

Specifically, the operation of FIG. 9 is implemented according to commands stored in a memory of a network.

First, the processor of the wireless device, for example, a central cloud server, may receive a service request signal from a UAV (S910). The service request signal of the UAV may include at least one of current location information of the UAV, channel quality information (received signal quality information of a BS), service type (or required QoS type) information, and capability information of the UAV.

The central cloud server may identify the required QoS based on the service type information and determine through which edge server type among an aerial edge server type and a ground edge server type a service will be provided, based on at least one of the identified QoS and channel quality information (S920).

The central cloud server may determine an optimal edge server corresponding to the determined edge server type based on the current location information of the UAV (S930). Additionally, the central cloud server may perform control such that the determined edge server provides a corresponding service (S940).

The method for providing the edge computing service and the network therefor according to the embodiments of the present disclosure as described above may be used to provide the edge computing service to a UE with high mobility according to various communication protocols as well as 3GPP.

As described above, the detailed description of the exemplary embodiments of the present disclosure has been given to enable those skilled in the art to implement and practice the disclosure. Although the disclosure has been described with reference to the exemplary embodiments of the present disclosure, those skilled in the art will appreciate that various modifications and variations may be made in the present disclosure without departing from the spirit or scope of the disclosure. For example, those skilled in the art may use constructions disclosed in the above-described embodiments in combination with each other.

Accordingly, the present disclosure should not be limited to the specific embodiments described herein, but should be accorded the broadest scope consistent with the principles and features disclosed herein.

What is claimed is:

1. A method of providing an edge computing service to a user equipment (UE) in a network of a mobile communication system, the method comprising:
receiving a service request signal from the UE;
determining an edge server type to support the UE, based on information included in the service request signal;
determining an edge server to support the UE, based on the edge server type determined to support the UE; and
providing the edge computing service to the UE through the edge server.

2. The method of claim 1, wherein the edge server type includes a ground edge server type and an aerial edge server type.

3. The method of claim 2, wherein the aerial edge server type is associated with an aerial edge server including one or more drones, or an aerial edge server including one or more satellites.

4. The method of claim 2, wherein the determining of the edge server type includes determining the edge server to support the UE as being any one of the ground edge server type and the aerial edge server type, based on the information included in the service request signal.

5. The method of claim 1, wherein the information included in the service request signal includes one or more of location information of the UE, channel quality information, service type information, and capability information of the UE.

6. The method of claim 1,
wherein the network is in communication with a central server,
wherein the UE comprises an uncrewed aerial vehicle (UAV), and
wherein the service request signal is received by the central server via a ground base station or an aerial base station.

7. The method of claim 6, wherein the information included in the service request signal includes one or more of vertiport information and corridor information of the UAV.

8. The method of claim 7, wherein the central server is configured to:
determine the edge server type to support the UE as a ground edge server type or an aerial edge server type; and
determine the edge server to support the UE among one or more edge servers related to the edge server type, based on one or more of the vertiport information and the corridor information.

9. The method of claim 2,
wherein the UE comprises one among a plurality of unmanned ground vehicles (UGVs) and a plurality of unmanned aerial vehicles (UAVs), and
wherein the aerial edge server comprises one among a plurality of aerial edge servers that provide edge computing service to the plurality of UGVs or the plurality of UAVs.

10. The method of claim 9, further comprising:
selecting the aerial edge server based on at least one of location information of the UE, movement path information of the UE, required quality levels of the UE, or any combination thereof, by using an Artificial Intelligence (AI) model.

11. A network apparatus of a mobile communication system for providing an edge computing service to a user equipment (UE), the network apparatus comprising:
one or more processors; and
a computer memory operably connected to the one or more processors and storing instructions that, when executed, configure the one or more processors to:
receive a service request signal from the UE;
determine an edge server type to support the UE, based on information included in the service request signal;
determine an edge server to support the UE, based on the edge server type determined to support the UE; and
provide the edge computing service to the UE through the edge server.

12. The network apparatus of claim 11, wherein the edge server type includes a ground edge server type and an aerial edge server type.

13. The network apparatus of claim 12, wherein the aerial edge server type is associated with an aerial edge server including one or more drones or an aerial edge server including one or more satellites.

14. The network apparatus of claim 13, wherein the one or more processors is further configured to determine the edge server to support the UE as being any one of the ground edge server type and the aerial edge server type, based on the information included in the service request signal.

15. The network apparatus of claim 11, wherein the information included in the service request signal includes one or more of location information of the UE, channel quality information, service type information, and capability information of the UE.

16. The network apparatus of claim 11, wherein the network apparatus includes a central server,
wherein the UE comprises an uncrewed aerial vehicle (UAV), and
wherein the service request signal is received by the central server via a ground base station or an aerial base station.

17. The network apparatus of claim 16, wherein the information included in the service request signal includes one or more of vertiport information and corridor information of the UAV.

18. The network apparatus of claim 17, wherein the central server is configured to:
determine the edge server type to support the UE as a ground edge server type or an aerial edge server type: and
determine the edge server to support the UE among one or more edge servers related to the edge server type, based on one or more of the vertiport information and the corridor information.

19. The network apparatus of claim 12,
wherein the UE comprises one among a plurality of unmanned ground vehicles (UGVs) and a plurality of unmanned aerial vehicles (UAVs), and
wherein the aerial edge server comprises one among a plurality of aerial edge servers that provide edge computing service to the plurality of UGVs or the plurality of UAVs.

20. The network apparatus of claim 19, wherein the aerial edge server is selected based on at least one of location information of the UE, movement path information of the UE, required quality levels of the UE, or any combination thereof, by using an Artificial Intelligence (AI) model.
